(19) United States
(12) Patent Application Publication
(10) Pub. No.: US 2010/0214213 A1
(43) Pub. Date: Aug. 26, 2010

(54) INTEGRATED CENTER PANEL WITH ROTARY CONTROL

(76) Inventors: Upton Beall Bowden, Canton, MI (US); Theodore Charles Wingrove, Canton, MI (US); Royce Duchante Channey, Ann Arbor, MI (US)

Correspondence Address: FRASER CLEMENS MARTIN & MILLER LLC, 28366 KENSINGTON LANE, PERRYSBURG, OH, 43551, US

(21) Appl. No.: 12/392,560

(22) Filed: Feb. 25, 2009

(51) Int. Cl. G06F 3/033; G06F 3/041

(52) U.S. Cl. 345/157; 345/173

(57) ABSTRACT

A control panel includes a display for providing visual images to a user and a rotary control including a shaft extending through an aperture formed in the display and a rotary knob coupled to the shaft, wherein the rotary control manages a control feature associated with the rotary control.

### FIELD OF THE INVENTION

The present invention relates to instrument and control panels. More particularly, the invention is directed to an integrated center panel including a display with an integrated rotary control knob and a method for forming the integrated center panel.

### BACKGROUND OF THE INVENTION

Most integrated center panels use either touch panels for a user interface or a combination of mechanical switches and rotary knobs. Rotary knobs are preferred for volume and temperature inputs. However, dedicated knobs take up significant space and require packaging outside of the display. Additionally, rotary knobs are typically dedicated for a specific function which is costly and inefficient from a packaging standpoint. Alternatively a programmable rotary encoder can be used and programmed to perform multiple functions. However this does not offer a scale associated with the knob or a label.

Current integrated center panels including touch screens include knobs and mechanical switches that are disposed outside a package space of the display. As such, the knobs and mechanical switches each require additional packaging, wiring connection, back lighting, and labels.

It would be desirable to develop an integrated center panel having a touch sensitive display and a method for forming the integrated center panel, wherein the display includes a rotary knob disposed therethrough.

### SUMMARY OF THE INVENTION

Concordant and consistent with the present invention, an integrated center panel having a touch sensitive display and a method for forming the integrated center panel, wherein the display includes a rotary knob disposed therethrough, has surprisingly been discovered.

In one embodiment, a control panel comprises: a display for providing visual images to a user; and an X/Y control extending through an aperture formed in the display, wherein the X/Y control manages a control feature associated therewith

In another embodiment, a control panel comprises: a display for providing visual images to a user; a rotary control including a shaft extending through an aperture formed in the display and a rotary knob coupled to the shaft, wherein the display provides a graphical scale around the rotary knob for representing a level of a control feature associated with the rotary control.

In yet another embodiment, a control panel for a vehicle comprises: a display for providing visual images to a user, wherein the display includes a touch sensitive function; a rotary control including a shaft extending through an aperture formed in the display screen and a rotary knob coupled to the shaft, wherein the display provides a graphical scale around the rotary knob for representing a level of a particular control feature associated with the rotary control; a controller for translating a motion of the shaft into an electrical signal to manage the control feature associated with the rotary control; and a control circuit to provide electrical intercommunication between a plurality of vehicle systems including the display and the controller.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a fragmentary perspective view of an interior of a vehicle including an integrated center panel according to an embodiment of the present invention;

FIG. 2 is a fragmentary front elevational view of the integrated center panel of FIG. 1;

FIG. 3 is a fragmentary cross sectional view of the integrated center panel of FIG. 2 taken along line 3-3;

FIG. 4 is a fragmentary perspective view of the integrated center panel of FIG. 2 showing an audio control function; and

FIG. 5 is a fragmentary perspective view of the integrated center panel of FIG. 2 showing a climate control function.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner.

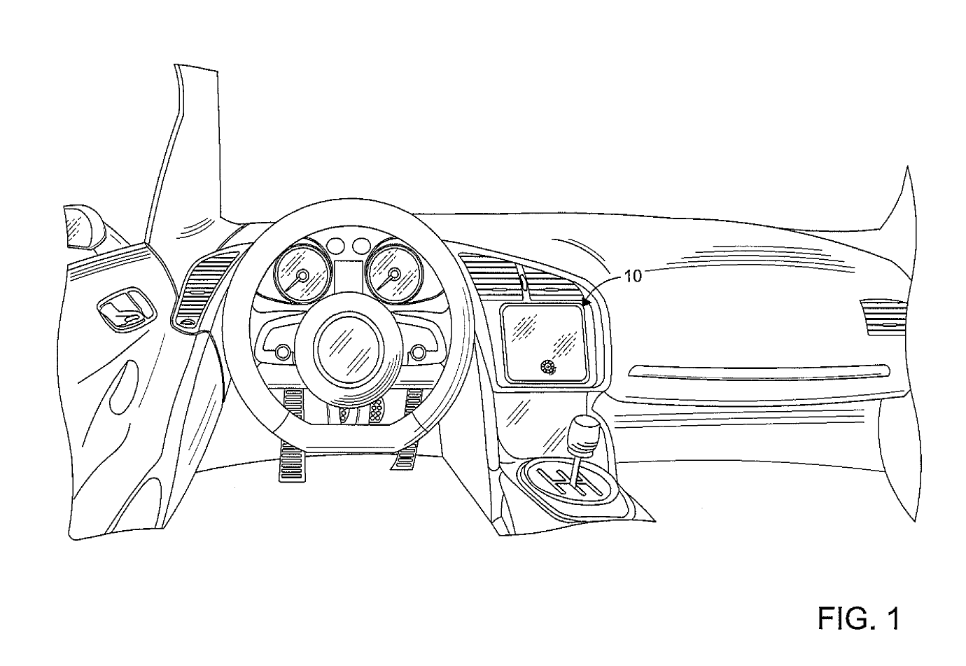

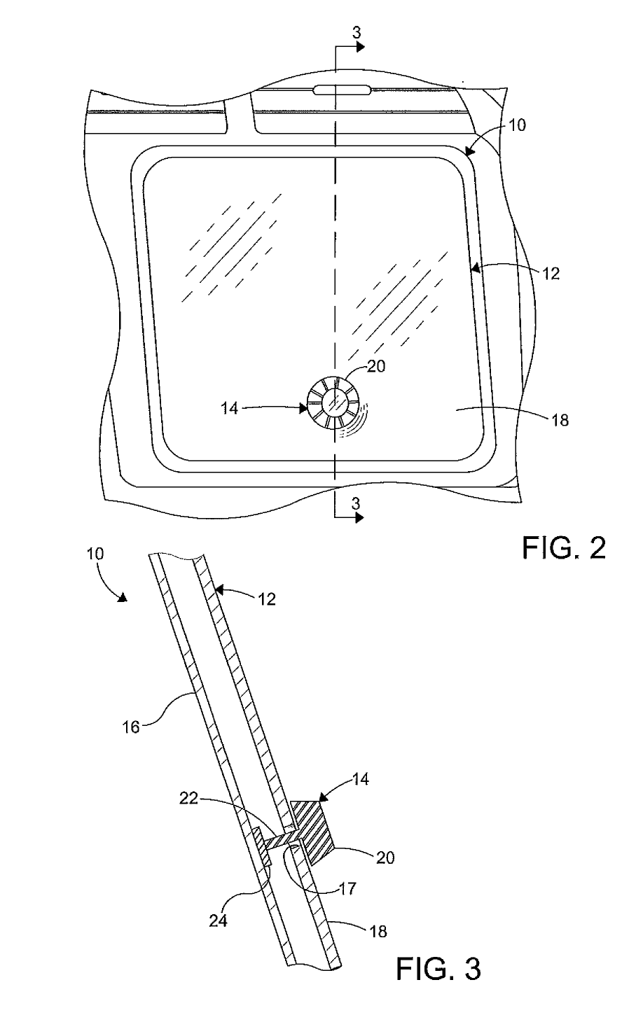

FIGS. 1, 2 and 3 illustrate an integrated center panel (ICP) 10 according to an embodiment of the present invention. The ICP 10 includes a display 12, an X/Y control 14 such as a rotary control, and a control circuit 16. As shown, the ICP 10 is disposed in a vehicle. However, it is understood that the technology disclosed herein may be used in non-vehicle applications.

The display 12 is a liquid crystal display (LCD) having touch sensitive functionality. It is understood that other displays having sensing capabilities may be used such as a backlit display panel with capacitance sensing features, for example. It is further understood that other displays such as plasma, OLED, and the like may be used, if desired. In certain embodiments the display 12 includes at least one of a plurality of functional and aesthetic films and layers such as protective layers, decorative layers, conductive layers, dielectric layers, barrier layers, and a substrate, for example. It is understood that the display 12 may include any number of layers, films, and features. It is further understood that the display 12 may be any size and shape.

In the embodiment shown, an aperture 17 is formed in a first surface 18 of the display 12 for receiving the control 14. As a non-limiting example, the display 12 may be manufactured to include the aperture 17. However, it is understood that the aperture 17 may be formed in a post-manufacturing procedure such as a drilling procedure, for example. It is further understood that any number of the apertures 17 may be formed in any portion of the display 12.

In the embodiment shown, the control 14 includes an adjustment device or rotary knob 20 coupled to a shaft 22. As shown, the shaft 22 is disposed through the aperture 17 formed in the display 12 and is coupled to a controller 24 on the control circuit 16. As a non-limiting example, the controller 24 is a rotary encoder adapted to translate a mechanical rotation into an electrical signal for processing. However, the controller 24 may be any device or system adapted to modify a particular control function in response to a rotational motion of the shaft 22 of the control 14. It is understood that the control 14 may further include a push button feature, wherein a mechanical “pushing” motion of the rotary knob 20 is used to execute a particular function. Any number of rotary controls may be used. Further, it is understood that other adjustment devices can be used as X/Y motion controls such as a joy stick, a lever, and combinations thereof with rotary controls, for example.

The control circuit 16 provides electrical intercommunication between multiple vehicle systems including the display 12 and the controller 24. As a non-limiting example, the control circuit 16 is a printed circuit board (PCB) or printed wiring board, known in the art. Additionally, the control circuit 16 provides a substrate for mounting the display 12, the controller 24, and other components of the ICP 10.

In use, the aperture 17 is formed in the display 12 thereby allowing the shaft 22 of the control 14 to be passed through the display 12. Thereafter, the rotary knob 20 is mounted adjacent the first surface 18 of the display 12. The rotary knob 20 is engaged by a user to select a range of driver and passenger inputs such as volume, temperature, bass, treble, balance, fade, and tune, for example. For each selected input, a graphical indicia or a graphical scale 26 is generated on the display 12. Additionally, end stops for the graphical scale 26 are programmed to the controller 24 and a function label 28 representing a current function of the control 14 is generated on the display 12. The display 12 provides visual and touch sensitive utility features to the user, while the control 14 provides an electro-mechanical control over a particular assigned driver and passenger input. As such, the user engages the rotary knob 20 of the control 14 to control a function projected by the display 12. As a non-limiting example, the user initiates a rotational motion of the rotary knob 20 to increase and decrease a level of the particular driver and passenger input controlled by the control 14. As a further example, the user cycles through the various driver and passenger inputs by pressing at least one of the rotary knob 20 and a touch sensitive indicia 30 projected on the display 12.

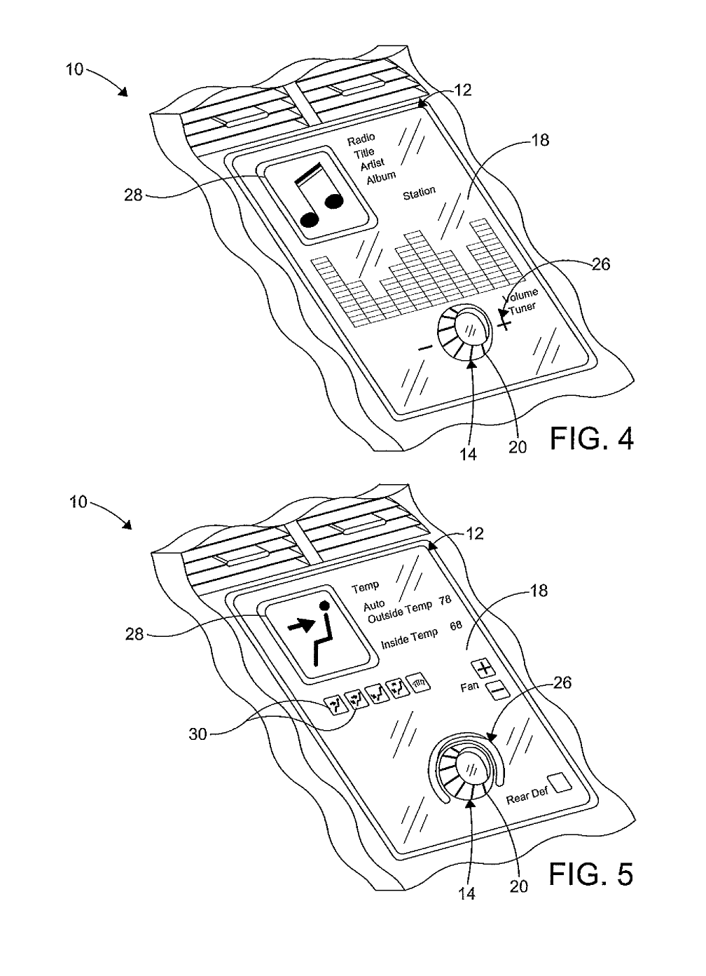

Specifically, FIG. 4 shows the display 12 representing an audio function of the control 14, wherein the function label 28 represents the audio function through a graphical indicia. It is understood that other labels may be used such as alphanumeric, for example. As shown in FIG. 4, the graphical scale 26 provides a measurement legend to the user for controlling a level of a driver and passenger input such as audio volume, for example.

FIG. 5 shows the display 12 representing a climate control function of the rotary 14, wherein the function label 28 represents the climate control function through a graphical indicia. As shown in FIG. 5, the graphical scale provides a measurement legend to the user for controlling a level of a particular driver and passenger input such as interior temperature, for example.

The invention maximizes packaging efficiency via the rotary knob shaft extending through the display surface, thereby minimizing the amount of packaging space needed for rotary knobs and controls in the vehicle.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A control panel comprising:
a display for providing visual images to a user; and
an X/Y control extending through an aperture formed in the display, wherein the X/Y control manages a control feature associated therewith.

2. The control panel according to claim 1, wherein the control panel is integrated with a vehicle.

3. The control panel according to claim 1, wherein the display includes a touch sensitive function.

4. The control panel according to claim 1, wherein the display is one of a liquid crystal display, plasma, and OLED.

5. The control panel according to claim 1, wherein the display includes at least one of a protective layer, a decorative layer, a conductive layer, a dielectric layer, a barrier layer, a conductive layer, and a substrate.

6. The control panel according to claim 1, wherein the X/Y control is one of a rotary control, a joy stick, a lever, and combinations thereof coupled to a controller for translating a motion of the X/Y control into an electrical signal to manage the control feature.

7. The control panel according to claim 1, wherein the X/Y control is a rotary encoder.

8. The control panel according to claim 1, wherein a function label representing the control feature associated with the X-Y control is generated on the display.

9. The control panel according to claim 1, wherein the user cycles through a plurality of the control features associated with the X/Y control by pressing at least one of the X/Y control and a touch sensitive indicia projected on the display.

10. A control panel comprising:
a display for providing visual images to a user;
a rotary control including a shaft extending through an aperture formed in the display and a rotary knob coupled to the shaft, wherein the display provides a graphical scale around the rotary knob for representing a level of a control feature associated with the rotary control.

11. The control panel according to claim 10, wherein the display includes a touch sensitive function.

12. The control panel according to claim 10, wherein the display is a liquid crystal display.

13. The control panel according to claim 10, wherein the shaft of the rotary control is coupled to a controller for translating a motion of the shaft into an electrical signal to manage the control feature associated with the rotary control.

14. The control panel according to claim 13, wherein the controller is a rotary encoder.

15. The control panel according to claim 10, wherein a function label representing the control feature associated with the rotary control is generated on the display.

16. The control panel according to claim 10, wherein the user cycles through a plurality of the control features associated with the rotary control by pressing at least one of the rotary knob and a touch sensitive indicia projected on the display.

17. A control panel for a vehicle comprising:
a display for providing visual images to a user, wherein the display includes a touch sensitive function;
a rotary control including a shaft extending through an aperture formed in the display screen and a rotary knob coupled to the shaft, wherein the display provides a graphical scale around the rotary knob for representing a level of a particular control feature associated with the rotary control;
a controller for translating a motion of the shaft into an electrical signal to manage the control feature associated with the rotary control; and
a control circuit to provide electrical intercommunication between a plurality of vehicle systems including the display and the controller.

18. The control panel according to claim 17, wherein the controller is a rotary encoder.

19. The control panel according to claim 17, wherein a function label representing the control feature associated with the rotary control is generated on the display.

20. The control panel according to claim 17, wherein the user cycles through a plurality of the control features associated with the rotary control by pressing at least one of the rotary knob and a touch sensitive indicia projected on the display.
